(19) United States
(12) Patent Application Publication
(10) Pub. No.: US 2015/0342010 A1
(43) Pub. Date: Nov. 26, 2015

(54) PERSONAL LIGHTING CONTROL SYSTEM AND METHOD

(71) Applicant: Shafrir ROMANO, Rishon Letzion (IL)

(72) Inventor: Shafrir ROMANO, Rishon Letzion (IL)

(21) Appl. No.: 14/658,259

(22) Filed: Mar. 16, 2015

Related U.S. Application Data
(60) Provisional application No. 62/001,087, filed on May 21, 2014.

(51) Int. Cl. H05B 37/02; H05B 33/08

(52) U.S. Cl. CPC H05B 37/0272; H05B 33/0842

(57) ABSTRACT

A method for monitoring and controlling lighting devices is disclosed, comprising: establishing a wireless link between each of the lighting devices and a wireless device, measuring in the wireless device a received wireless signal strength for each of the received wireless signals, creating in the wireless device a lighting device list such that the included lighting devices are ordered respectively to their received wireless signal strengths, and performing in the wireless device at least one predefined action based on the lighting device list.

### FIELD OF THE INVENTION

The present invention relates generally to lighting control, and more particularly, to methods and systems for controlling lighting by means of wireless devices.

### BACKGROUND OF THE INVENTION

Wireless based lighting control has become a substantial part of the rapidly emerging smart home trend and technologies. An important aspect of any smart home system is an effective and user friendly appliance discovery and identification mechanism. One such mechanism known in the art is Simple Device Discovery Protocol (SDDP), which allows for finding and adding SDDP-enabled devices to the smart home system. Another technique uses smartphone camera and screen to display lighting devices present in the vicinity of the user, thereby allowing him to select and control one or more of the displayed lighting devices.

Thus, it would be desirable to achieve an appliance identification technique that would provide the user with a functionally ordered appliance monitoring solution combined with an automatic control option that depends on his current location in the smart home area.

### SUMMARY OF THE INVENTION

Accordingly, it is a principal object of the present invention to provide improved methods and systems for monitoring and control of appliances, in particular Light Emitting Diode (LED) based lighting devices, in a smart home environment. Thus, in accordance with an embodiment of the present invention, a method for monitoring and controlling lighting devices, in particular LEDs, is disclosed, comprising: Establishing a wireless link between each of the lighting devices and a wireless device, measuring in the wireless device a signal strength for each of the wireless signals received from the lighting devices, creating in the wireless device a lighting device list such that the included lighting devices are ordered respectively to their received signal strengths, and performing in the wireless device at least one predefined action based on the lighting device list.

In an embodiment, the at least one predefined action comprises displaying the lighting device list. In another embodiment, the at least one predefined action comprises selecting at least one of the first lighting devices present in the lighting device list for monitoring and/or controlling the selected at least one of the first lighting devices. In some embodiments, the monitoring and/or controlling are initiated by the wireless device.

In an embodiment, including a certain lighting device in the lighting device list comprises verifying that the certain lighting device has a compatible identification code. In another embodiment, including a certain lighting device in the lighting device list comprises checking the access authorization level of the wireless device to the certain lighting device.

In embodiments of the present invention, the wireless link comprises at least one of the wireless protocols selected from the group comprising Bluetooth, Wi-Fi ZigBee and their related variants.

In accordance with an embodiment of the present invention, there is also provided a non-transitory computer readable storage medium configured to store program instructions executable by a processor in a wireless device wherein the wireless device further comprises a wireless stage configured to maintain wireless communication with one or more lighting devices and to issue a signal strength indication for each of the wireless signals received from the one or more lighting devices, the program instructions arranged to cause the processor to read the signal strength indications, to create a lighting device list that includes the one or more lighting devices such that they are ordered respectively to their signal strength indications, and to perform at least one predefined action based on the lighting device list.

In accordance with an embodiment of the present invention, there is also provided a lighting system comprising: One or more lighting devices, and a wireless device comprising a wireless stage configured to maintain wireless communication with the one or more lighting devices and to issue a signal strength indication for each of the wireless signals received from the one or more lighting devices, a processor and a memory operatively coupled to the processor, the memory storing program instructions that when executed by the processor cause the processor to read the signal strength indications, to create a lighting device list that includes the one or more lighting devices such that they are ordered respectively to their signal strength indications, and to perform at least one predefined action based on the lighting device list.

### BRIEF DESCRIPTION OF THE DRAWINGS

The present invention will be more fully understood from the following detailed description of the embodiments thereof, taken together with the drawings in which:

FIG. 1 is a block diagram that schematically illustrates a lighting system, in accordance with an embodiment of the present invention; and

FIG. 2 is a flowchart that schematically illustrates a method for monitoring and controlling lighting devices, in accordance with an embodiment of the present invention.

### DETAILED DESCRIPTION OF EMBODIMENTS

For the purposes of discussing this invention the following terms will be used to describe the primary aspects of the invention. A lighting device is a wirelessly-controllable lighting driver and an attached lighting source comprising, in an embodiment, one or more LEDs. A wireless device is a portable computing device such as a smartphone, tablet or remote controller. A device application is a user-facing software application running on one or more processors within the wireless device.

Embodiments of the present invention provide improved methods and systems that allow a user of an automated lighting system to easily monitor and control lighting devices belonging to the system, in particular, to automatically control the lighting in his vicinity while walking in the area of the automated lighting system.

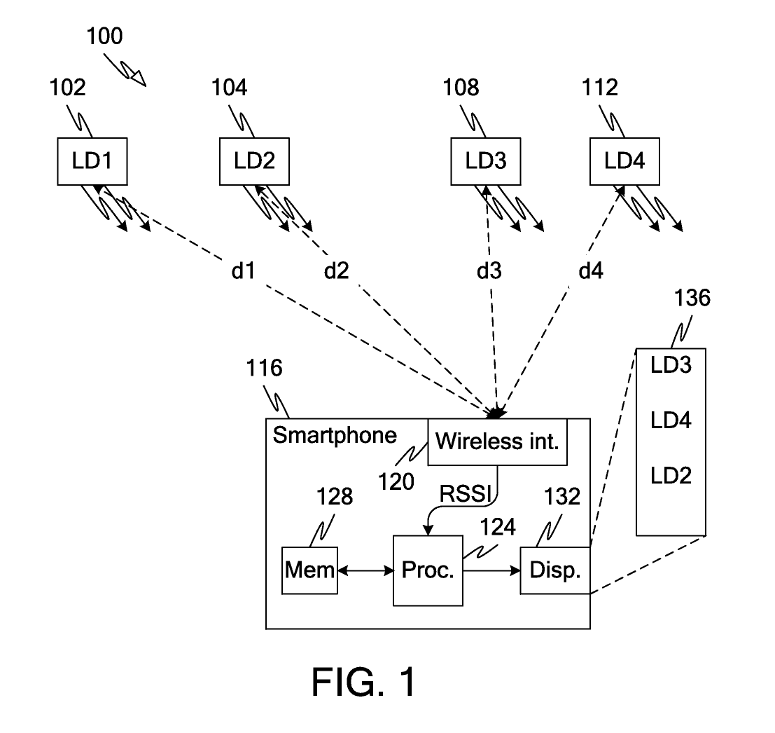

Referring to FIG. 1 there is shown a block diagram that schematically illustrates a lighting system 100, in accordance with an embodiment of the present invention. In the figure, lighting devices (LDs) 102, 104, 108 and 112 are controllable by a wireless device 116. Wireless device 116 comprises a wireless interface 120 through which communication with LDs 102-112 can be maintained for monitoring the LDs and for affecting their lighting parameters such as intensity, color etc. In an embodiment, the wireless communication is Bluetooth based. In other embodiments, other wireless protocols may be used, such as Wi-Fi or ZigBee. The distances between wireless device 116 and LDs 102-112 are depicted in FIG. 1 as d1 to d4 respectively.

The distances d1-d4 will vary while the user of wireless device 116, not shown in FIG. 1 and shortly denoted herein as ‘user’, is in motion. Let us assume that in a given moment wireless device 116 maintains Bluetooth links with LDs 104-112, while LD 102 is out of its Bluetooth range. Wireless interface 120 is configured to measure the strength of the wireless signal received through each Bluetooth link that it maintains and to issue, as a result, a Received Signal Strength Indicator (RSSI) for each link. The RSSI associated with a wireless link thus constitutes an indication representing the level of signal received from the corresponding LD. Processor 124 normally reads RSSIs as part of handling wireless communication through wireless device 116. A memory 128, attached to processor 124, stores a device application operable by the user. The device application described herein may be, typically, one of multiple applications that are stored in memory 128.

When the device application is executed, it causes processor 124 to create a lighting device list, ordered respectively to the available RSSIs, and to provide the list to a display 132, typically the screen of wireless device 116. Such an example list is indicated in FIG. 1 by reference numeral 136. As the RSSI level corresponding to an LD is typically proportional to its proximity to wireless device 116, LDs 104-112 are placed in list 136 respectively to their proximity to wireless device 116. Now, when the user looks at list 136 on the screen of wireless device 116, he can easily identify the LDs in his vicinity and, thereby, easily and intuitively control them. For example, clicking the top LD in the list, for any desired control action, would affect the LD that is the nearest to the user, which would be most typically the desired LD selection. Typical control actions may be turning the selected LD on, varying its dimming level or its light temperature.

In some embodiments, the device application causes processor 124 to automatically control the top one or more LDs, e.g. turning them on without resorting to any user intervention, and to maintain the on state of each LD as long as whose corresponding RSSI exceeds a given threshold. An example of this feature may be a situation in which a person is walking through a dark or dimly lit hallway. If he is carrying a smartphone in his pocket wherein the described device application is installed, it would then operate to turn on and off lighting lamps corresponding to the person's advance along the hallway, for lighting up his path.

The device application is typically downloaded to wireless device 116 from some server over the internet, wherein it is typically stored, possibly in a compressed form, in some non-transitory computer readable storage medium.

The above description has focused on the specific elements of lighting system 100 that are essential for understanding certain features of the disclosed techniques. Conventional elements that are not needed for this understanding have been omitted from FIG. 1 for the sake of simplicity, but will be apparent to persons of ordinary skill in the art. The configuration shown in FIG. 1 is an example configuration, which was chosen purely for the sake of conceptual clarity. In alternative embodiments, any other suitable configurations can also be used.

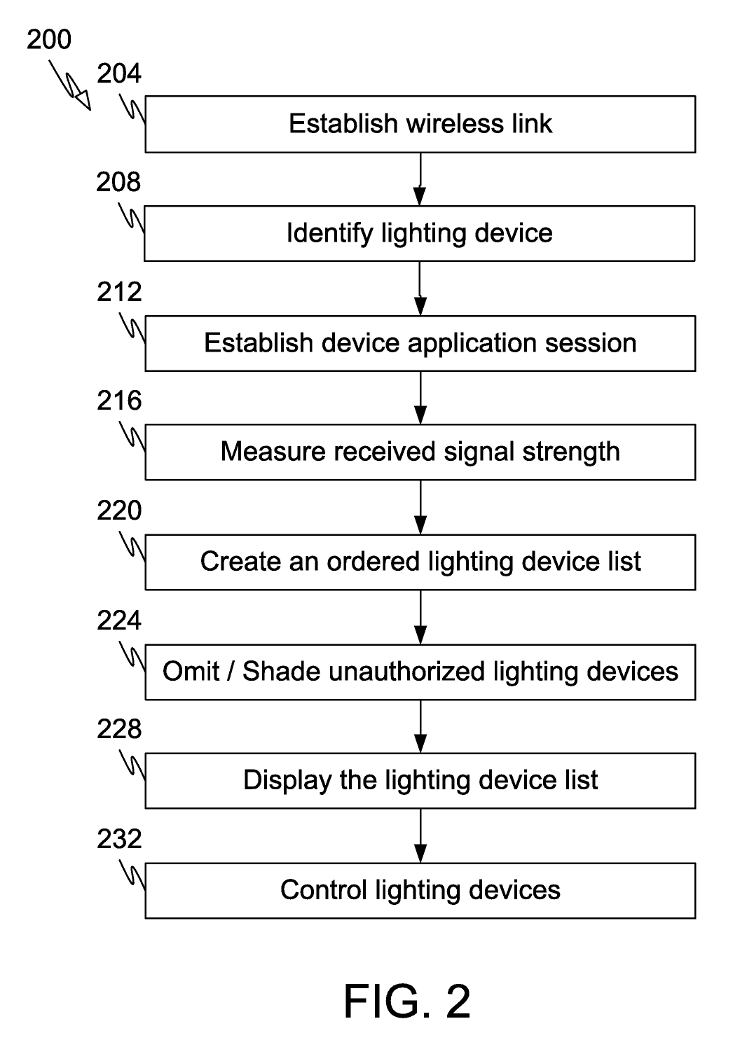

FIG. 2 shows a flowchart 200 that schematically illustrates a method for monitoring and controlling lighting devices, in accordance with an embodiment of the present invention. The method begins with an establishing step 204, in which an operating system running on processor 124 establishes a wireless link to LDs 104-112. In an identifying step 208 that follows, the device application checks compatibility of LDs 104-112 to the application, according to identification codes that they send as part of the wireless protocol. Next, in an establishing step 212, the device application establishes an application session with each of LDs 104-112. In a measuring step 216, the device application reads the strength of wireless signal transmitted from each of LDs 104-112, based on their corresponding RSSIs provided by wireless interface 120.

In a creating step 220 that follows, the device application creates an ordered lighting device list wherein LDs 104-112 are placed respectively to their proximity to wireless device 116, as explained above. In an optional limiting step 224 that follows, the device application either excludes from the LD list or designates as access-limited, LDs to which the wireless device access authorization level is limited. A displaying step 228 constitutes a typical action that may result from the previous method steps, wherein the device application displays the LD list on the wireless device screen. This would allow the user to issue any desired monitoring or control action on the displayed LDs, as described above and depicted in final step 232. In an embodiment, steps 228 and 232 can be additive or interchangeable, depending on the predefined settings of the device application.

Flowchart 200 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 2 for the sake of simplicity.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for monitoring and controlling lighting devices comprising:
establishing a wireless link between each of the lighting devices and a wireless device;
measuring in the wireless device the strength of a wireless signal received from each of the lighting devices;
creating in the wireless device a lighting device list such that the lighting devices included in the list are ordered respectively to their received wireless signal strengths; and
performing in the wireless device at least one predefined action based on the lighting device list.

2. The method of claim 1, wherein the lighting devices are Light Emitting Diodes (LEDs).

3. The method of claim 1, wherein the at least one predefined action comprises displaying the lighting device list.

4. The method of claim 1, wherein the at least one predefined action comprises selecting at least one lighting device from the top of the lighting device list for at least one of monitoring and controlling the selected at least one lighting device.

5. The method of claim 4, wherein the at least one of monitoring and controlling the selected at least one lighting device is initiated by the wireless device.

6. The method of claim 1, wherein including a certain lighting device in the lighting device list comprises verifying that the certain lighting device has a compatible identification code.

7. The method of claim 1, wherein including a certain lighting device in the lighting device list comprises checking an access authorization level of the wireless device to the certain lighting device.

8. The method of claim 1, wherein the wireless link comprises at least one of the wireless protocols selected from the group comprising Bluetooth, Wi-Fi ZigBee and their related variants.

9. A non-transitory computer readable storage medium configured to store program instructions executable by a processor in a wireless device wherein the wireless device further comprises a wireless stage configured to maintain wireless communication with one or more lighting devices and to issue a signal strength indication for the wireless signal received from each of the one or more lighting devices, the program instructions arranged to cause the processor to perform the steps of: reading the signal strength indications; creating a lighting device list that includes the one or more lighting devices such that they are ordered respectively to their received signal strength indications; and performing at least one predefined action based on the lighting device list.

10. The non-transitory computer readable storage medium of claim 9, wherein the one or more lighting devices are Light Emitting Diodes (LEDs).

11. The non-transitory computer readable storage medium of claim 9, wherein the at least one predefined action comprises displaying the lighting device list.

12. The non-transitory computer readable storage medium of claim 9, wherein the at least one predefined action comprises selecting at least one lighting device from the top of the lighting device list for at least one of monitoring and controlling the selected at least one lighting device.

13. The non-transitory computer readable storage medium of claim 12, wherein the at least one of monitoring and controlling the selected at least one lighting device is initiated by the program instructions.

14. The non-transitory computer readable storage medium of claim 9, wherein including a certain lighting device in the lighting device list comprises verifying that the certain lighting device has a compatible identification code.

15. The non-transitory computer readable storage medium of claim 9, wherein including a certain lighting device in the lighting device list comprises checking an access authorization level of the wireless device to the certain lighting device.

16. The non-transitory computer readable storage medium of claim 9, wherein the wireless communication comprises at least one of the wireless protocols selected from the group comprising Bluetooth, Wi-Fi ZigBee and their related variants.

17. A lighting system comprising:
one or more lighting devices; and
a wireless device comprising a wireless stage configured to maintain wireless communication with the one or more lighting devices and to issue a signal strength indication for the wireless signal received from each of the one or more lighting devices, a processor and a memory operatively coupled to the processor, the memory storing program instructions that when executed by the processor cause the processor to perform the steps of: reading the signal strength indications, creating a lighting device list that includes the one or more lighting devices such that they are ordered respectively to their received signal strength indications, and performing at least one predefined action based on the lighting device list.

18. The lighting system of claim 17, wherein the one or more lighting devices are Light Emitting Diodes (LEDs).

19. The lighting system of claim 17, wherein the at least one predefined action comprises displaying the lighting device list.

20. The lighting system of claim 17, wherein the at least one predefined action comprises selecting at least one lighting device from the top of the lighting device list for at least one of monitoring and controlling the selected at least one lighting device.

21. The lighting system of claim 20, wherein the at least one of monitoring and controlling the selected at least one lighting device is initiated by the program instructions.

22. The lighting system of claim 17, wherein including a certain lighting device in the lighting device list comprises verifying that the certain lighting device has a compatible identification code.

23. The lighting system of claim 17, wherein including a certain lighting device in the lighting device list comprises checking an access authorization level of the wireless device to the certain lighting device.

24. The lighting system of claim 17, wherein the wireless communication comprises at least one of the wireless protocols selected from the group comprising Bluetooth, Wi-Fi ZigBee and their related variants.
